(19) United States
(12) Patent Application Publication
(10) Pub. No.: US 2017/0236088 A1
(43) Pub. Date: Aug. 17, 2017

(54) DELIVERY METHOD AND SYSTEM

(71) Applicant: DeliveryCircle LLC, New Castle, DE (US)

(72) Inventor: Vijaya Rao, Bear, DE (US)

(21) Appl. No.: 15/238,076

(22) Filed: Aug. 16, 2016

Related U.S. Application Data
(60) Provisional application No. 62/295,248, filed on Feb. 15, 2016.

(51) Int. Cl. G06Q 10/08; G06Q 10/10; G06Q 10/06; G06F 17/24

(52) U.S. Cl. CPC G06Q 10/083; G06F 17/246; G06Q 10/10; G06Q 10/063112

(57) ABSTRACT

An automated method and system for delivering items by connecting delivery persons with buyers and sellers. The delivery system substitutes human labor with software and automates the dispatching, including utilizing a driver polling system to assign deliveries to available drivers. The system may be applied to temporary or hourly shift workers across different industries to assign schedules and poll workers as to their availability.

### BACKGROUND

Disclosed embodiments relate to systems, components and methods for delivering packages and other items through an automated system. In particular, the disclosure relates to the coordination of merchants, customers and delivery personnel through a dynamic system.

Traditional delivery services typically do not allow, or allow only to a limited extent, selection of pick-up times, drop-off times and delivery personnel. Conventional services also require numerous non-automated steps or semi-automated steps, for example, billing and payment of drivers. Even if such ancillary services are automated, they may not be fully integrated with the delivery intake request and execution processes.

### SUMMARY

According to the disclosure, systems, components and methods are provided for coordinating and automatically implementing a delivery process through steps including, entry of a delivery request, identification of one or more drivers, notification to drivers of delivery requests, acceptance or rejection of delivery requests, executing deliveries, confirmation of pickup and delivery, logging of information including images, return trip deliveries, payments to drivers and receipt of payment from merchants.

Embodiments disclosed include a method and system for delivering items by connecting delivery persons with buyers and sellers. The system may be configured to embed a button, or other application program interface, on a seller's website, such as on a purchase checkout page, that a buyer can click on to select the delivery method. A list of delivery persons along with delivery charges, ratings, availability, vehicle capacity and zip codes serviced may be provided. Upon a delivery person being selected, the system notifies the delivery person about the item to be picked up. Each stage of the delivery process can be recorded in the system and can be reviewed and compiled into reports or accessed as desired. A seller may include the delivery service system as a choice of carriers displayed in a drop down menu. The system may serve as a fully automated or substantially automated dispatching service for business-to-business, business-to-consumer and consumer-to-customer, and may include an automated driver job-acceptance and confirmation polling process, with reminders and driver tracking.

It is noted that the term “merchant” or “seller” may be used for a party whose products or other items are being delivered, but the invention in its broadest sense may apply to parties not traditionally falling under the category of “merchant” such as, for example, accounting or law firms that may use the service to deliver documents, among others. Aspects of the disclosure may also apply to other scenarios such as coordination of shift or temporary workers, or employees or contractors with flexible schedules, for example. The term “delivery person” and “driver” may also be used interchangeably and are used broadly to include any mode of travel to make the delivery.

### BRIEF DESCRIPTION OF THE DRAWINGS

Disclosed embodiments will be explained below on the basis of the associated drawings. In the drawings:

FIG. 1 is a flow chart showing steps of an illustrative delivery system.

FIG. 2 is a system diagram of an illustrative delivery system.

FIG. 3 is an illustrative interface through which a buyer, seller and delivery person may sign up to utilize a delivery system.

FIG. 4 is an interaction diagram representing the structural organization of objects that send and receive messages and the dynamic, interactive behavior of an illustrative delivery system.

FIG. 5 is a sitemap according to an illustrative embodiment showing the delivery system webpages accessible to administrators, buyers, sellers, delivery persons, and others.

FIG. 6 is a diagram showing scheduling multiple deliveries via a spreadsheet upload, according to an illustrative embodiment.

FIG. 7 depicts a delivery system web page according to an illustrative embodiment of a delivery system.

FIG. 8 shows an illustrative driver polling notice.

FIG. 9 is an illustrative embodiment of a notice to a delivery person that describes the proposed delivery job, the items to be delivered, and instructions on accepting or rejecting the assignment.

FIG. 10 is a delivery system webpage accessed by a seller through which the seller can manage deliveries, including selecting delivery persons.

FIG. 11 depicts an illustrative driver polling workflow.

FIG. 12 shows an illustrative procedure for scanning and uploading delivery or shipping documents.

FIG. 13 is a flow chart of an illustrative return process.

FIG. 14 depicts an illustrative system on which embodiments of the delivery system may be carried out.

### DETAILED DESCRIPTION OF THE DISCLOSED EMBODIMENTS

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. The terms first, second, third, etc. or other numerical designation may be used to distinguish one element from another without implying sequence. In some illustrative embodiments, well-known processes, well-known device structures, and well-known technologies are not described in detail.

Terminology may be used herein for the purpose of describing particular illustrative embodiments only and is not intended to be limiting. The singular form of elements may be intended to include the plural forms, unless the context indicates otherwise. The method steps, processes, and operations described herein are not to be construed as necessarily requiring their performance in the particular order discussed or illustrated, unless specifically identified as an order of performance or a particular order is inherently necessary for the invention to be operational. It is also to be understood that additional or alternative steps may be employed.

It is noted that in some embodiments, elements that are connected or otherwise coupled with one another may be directly coupled or may have intervening elements. Other words used to describe the relationship between elements should be interpreted in a like fashion (e.g., “between,” “adjacent,” “after,” “before,” etc.).

Embodiments in accordance with the disclosure include the methods described herein and their equivalents, non-transitory computer readable media programmed to carry out the methods and a computer system configured to carry out the methods. Further included is a hand-held device or a plurality of hand-held devices comprising components that include any of the methods, non-transitory computer readable media programmed to implement the instructions or carry out the methods, and systems to carry out the methods. The computer system, and any sub-computer systems will typically include a machine readable storage medium containing executable code; one or more processors; memory coupled to the one or more processors; an input device, and an output device connected to the one or more processors to execute the code. A machine-readable medium may include any mechanism for storing or transmitting information in a form readable by a machine, such as a computer processor. The information may be stored, for example, in volatile or non-volatile memory.

Modules, data structures, and the like are referred to as such for ease of discussion, and are not intended to imply that any specific implementation details are required. For example, any of the described modules or data structures may be combined or divided into sub-modules, sub-processes or other units of computer code or data as may be required by a particular design or implementation. In the drawings, specific arrangements or orderings of schematic elements may be shown for ease of description but may be suitably modified to implement embodiments of the disclosure. In general, schematic elements used to represent instructions or modules may be implemented using any suitable form of machine-readable instruction, and each such instruction may be implemented using any suitable programming language, library, application program interface (API), or other software development tools or frameworks. Similarly, any suitable electronic arrangement or data structure of elements described may be implemented. Further, some connections, relationships or associations between elements may be simplified or not shown in the drawings so as not to obscure the disclosure.

It will also be understood that the term “module” as used herein does not limit the functionality to particular physical modules, but may include any number of tangibly-embodied software or hardware components. A module will typically comprise a tangible computer readable medium having computer-readable program code embodied therein, wherein the computer-readable program code is adapted to be executed by a processor (working in connection with an operating system) to implement one or more functions and methods of the module. In this regard, the program code may be implemented in any suitable language and may as any suitable type of code. A module may also comprise a plurality of modules functioning in concert to carry out the intended function.

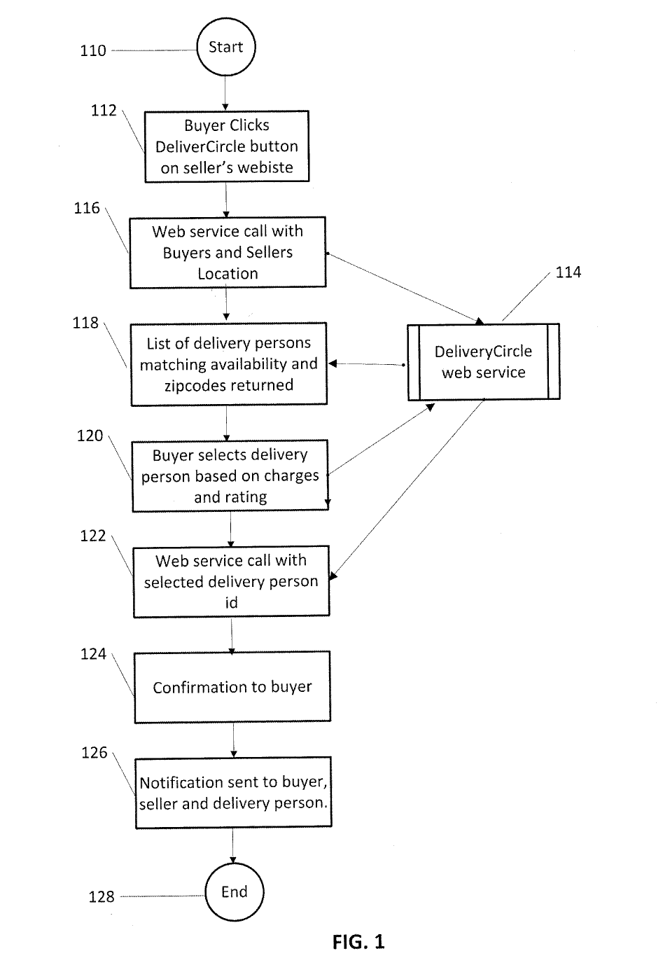

FIG. 1 is a flow chart showing steps beginning with a buyer accessing the delivery service through a seller's website, a driver taking the delivery job and a notification sent to the buyer, seller and driver that a delivery plan is in place. It is noted that the term “driver” is used broadly, and can include, for example, a person making deliveries by foot, or a worker in an embodiment directed to coordinating shifts. Each driver or group of drivers are set up with a profile containing information that can be used in the delivery system process, such as vehicle capacity or load or address or portions of an address to identify a driver's location, for example. The profile may also include information that is input by a person other than the driver, such as a driver rating. Some or all of the driver's profile will be visible to the one or more of the buyer, seller and other drivers, and be accessible through the delivery web service.

The process starts in circle 110. In step 112 a buyer initiates a delivery by clicking on a button on a seller's website, utilizing a software application on a cell phone, a tablet computer, or other device on which the requisite software is loaded or through which it can be accessed. In an exemplary embodiment, buyer 228 does not have to navigate away from the seller's checkout page.

The buyer's initiation of the delivery in step 112 causes a call to be transmitted in step 116 to a delivery web service in block 114. The “call” may be in the form of an email, text, telephone call or other messaging vehicle. The call may include the buyer's and seller's locations for pick-up and delivery purposes. These may be entered at the time the delivery is initiated by the buyer, or they may be selected from an available list, such as may be the case where the buyer and seller have done business together before.

After receiving the delivery request in block 114, the delivery web service relays a list of delivery persons to the buyer in step 118. The list may include drivers the buyer has previously selected, or it may include a full list of driver's in the area. A full list may be ordered based on a buyer's previous input or input provided at the time the delivery is being initiated.

In step 120 the buyer selects a driver based on any desired criteria offered, provided the driver is available to carry out the desired delivery. Criteria may include, for example, availability, fees, zip codes serviced and vehicle capacity. Typically, only drivers that can make a delivery will be listed, but other available criteria may be weighed, such as the driver's fee schedule and service rating. Drivers may determine their own fee rates, either entirely or within parameters set by the delivery service host. Even if a buyer has preselected drivers that it wants to appear on lists and the software creates a workable plan as to load for each driver or timing, for example, the buyer may have the option to view the selections before committing to the request, and may in exemplary embodiments modify the choice of drivers and other criteria before finalizing the delivery request.

Once the buyer selects the driver or drivers, the delivery web service is notified of the choice in step 122. The data representing the buyer's choice is provided to the delivery web service, upon which the delivery web service sends a confirmation the buyer in step 124.

In step 126, the buyer, seller and delivery person are notified that the delivery has been set up, and the process ends at step 128.

In other embodiments a seller may select the drivers. Drivers may be identified, for example, by zip code information contained in their profiles.

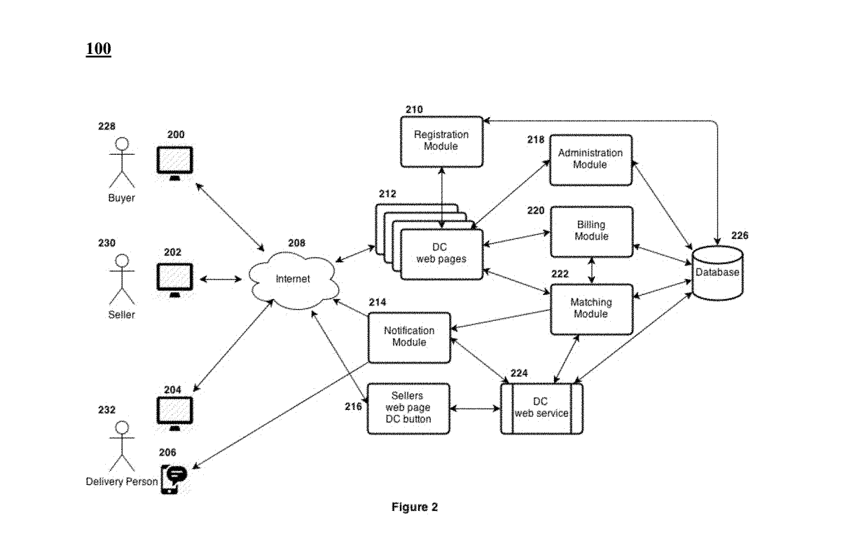

FIG. 2 is a system diagram of a delivery system 100, according to an illustrative embodiment. Three parties are shown that participate in this illustrative process, a buyer 228, a seller 230 and a delivery person 232. Buyer 228 accesses the Internet 208 with device 200, seller 230 accesses the Internet 208 through device 202, and delivery person 232 accesses the Internet 208 through device 204. Devices 200, 202, 204 may be for example, a tablet computer, laptop computer, desktop computer, personal digital assistant (PDA), or any other device that can execute coded instructions to carry out the methods described herein. As shown in FIG. 2, data flows to and from the Internet 208 to and from buyer 228, seller 230 and delivery person 232.

Delivery web service 224 provides the software application or portions thereof to coordinate components and steps of delivery system 100 and associated methods. The service provider of delivery web service implements the delivery services and makes them available over the Internet 208. Delivery web service 224 can be accessed by other programs over the Internet 208, so by extension, by buyer 200, seller 230 and delivery person 232 through a browser, such as Internet Explorer. Mozilla Firefox, for example, or through a software application (“app”) such as installed on a personal digital assistant (PDA) or other handheld device. Delivery web service 224 may use a standardized messaging system such as XML to encode communications to and from delivery web service 224. Preferably communications will not require any particular operating system, i.e. will be platform independent, which is generally the case if a standardized XML messaging system is used or other open standard programming languages and platforms are used to exchange data. So for example, there may be interoperability between Linux and Windows applications or between Java and Perl.

Delivery web service 224 may be a conventional web service using Internet standards and protocols for exchanging data between applications or systems that is self-contained, self-describing, modular, distributed, dynamic application that can be described, published, located, and invoked over a network. The applications can be local, distributed, or web-based, for example. Standards such as TCP/IP, HTTP, Java, HTML and XML. Delivery web service, alternatively, may be implemented over a private network, such as an intranet.

An illustrative Delivery web service 224 may have the following components, a web services description language (WSDL), a standard for describing, publishing, and finding web services, such as a Universal Description, Discovery and Integration (UDDI) component, and a messaging protocol that allows programs running under different operating systems in the network to communicate with each other, such as XML-RPC or simple object access protocol (SOAP) for example. In an exemplary embodiment, an API, such as a Representational State Transfer architecture (RESTful) is used with a language-independent data format, such as JSON, which is an open-standard format employing human-readable text to transmit data objects or other data structure that stores or references data.

Typically, buyer 228 will, through an existing web service, open a network connection and sends an XML request, for example, This may be performed by clicking on a button on a website operated by a seller 230, for example, such as shown in block 216. The access button may be for example, on the purchasing pages of a seller's website. Software code for delivery system 100 may contain multiple portions of code, each applicable to different platforms that buyer 228 may be using.

A database 226 contains information necessary to select a delivery person and to implement a delivery from seller 230 to buyer 228. Database 226 may be contained in one or more storage devices, such as random access memory (RAM), read only memory (ROM), for example. Database 226 may include for example:
profiles of delivery persons 232, which may be the form, for example of a central registry of drivers;
profiles of sellers 202;
profiles of buyers 228.

A profile of a delivery person 232 may include, for example, load capacity, ratings, personal information, such as name, address, email address, telephone number, availability, payment information, rates, etc. In an exemplary embodiment, the delivery person registers on the system website supplying his/her email-ID or other notification system identification, and other personal information, which may include for example, date of birth, social security number, driver's license and mobile telephone number. The system then generates a random passcode, such as an alphanumeric code, that is sent to the delivery person's mobile telephone. The delivery person enters the passcode on the delivery system website to confirm the number belongs to him/her. Personal information may be used for various tasks, including for example, background checks. A seller who intends to use the delivery system may obtain the passcode for the button from the delivery system website.

A profile of a buyer may include, for example: pick up and drop off addresses, pick up times, item descriptions, and any special instructions to drivers. The buyer may pay for deliveries on the website. Deliveries may be scheduled automatically, generating a confirmation notice, by email or text for example, with tracking that goes to the buyer. In an illustrative embodiment, a buyer is someone who wants to make and receive a purchase, possibly in the same day, but does not have the time or the right type of vehicle, for example, and the merchant does not offer delivery service. A buyer is associated as a shopper in the delivery system. Generally, certain features, such as spreadsheet upload and multiple delivery scans will not be available to a buyer.

A profile of a seller may include, for example, pick up and drop off addresses, pick up times, item descriptions, and any special instructions to the driver. A seller may pay for the delivery on the website. Deliveries may be scheduled automatically, generating a confirmation notice, by email or text for example, with tracking goes back to the seller. In addition to individual deliveries, a seller may upload a spreadsheet with, for example, 200 deliveries, all to be picked up from the same location but dropped off to any number of different locations. Once the system has been populated with the relevant information, these multiple deliveries can be initiated with just one click, or a few simple online steps. In an exemplary embodiment of the delivery system, the system Is configured to allow the seller to add and delete routes as well as change drivers for the routes. The system may also allow the seller to see uploaded manifests with signatures as well as pictures of delivered items or related documents or other information in real time.

In an illustrative embodiment, a seller is a business that has a route-based delivery need but does not want to hire in-house staff with fixed overhead. A seller may also be, for example, a business that cannot predict the number of deliveries each day and wants to pay per delivery. A seller using embodiments of the delivery system may also be a business that has an immediate need that may be out of the ordinary course of business, unexpected, or beyond the business's current delivery capabilities, such as a mission critical need for same day delivery that arises, or a business that adheres to a just-in-time procedure, i.e. deliveries made immediately before the delivered items are required.

Delivery web service can access data from database 226. Database 226 is also coupled to a registration module 210, an administration module 218, a billing module 220 and a matching module 222.

Administration module 218 retrieves and delivers information from database 226 and data entered through delivery service webpages 212. Data and information may also flow from administration module 218 to database 226 and webpages 212. Administration module 218 allows for a delivery system administrator to set preference-based routes for the merchants, enter deliveries on behalf of the merchants, assign dedicated drivers, and assign driver loads for each merchant. These tasks may be automated via administration module 218 and allow input by the administrator.

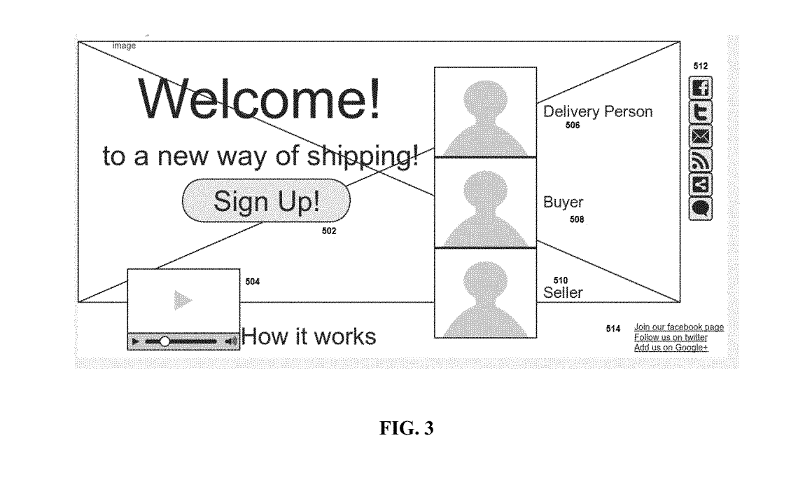

Registration module 210 executes instructions to allow a seller to sign up for use of delivery system 100, a buyer 228 to register for the service, and a delivery person 232 to sign up to be a driver. FIG. 3 is an illustrative interface through which buyer 228, seller 230 and delivery person 232 may sign up to utilize delivery system 100, or serve as a delivery person. Returning to FIG. 2, registration modules 210 transmits and receives data to and from database 226 and webpages 212.

Matching module 222 matches delivery persons 232 to sellers 230 to coordinate delivery of a seller's product to a buyer (a B2C delivery). Matching module 222 considers various criteria, including, for example, parameters associated with each delivery person 232 such as zip codes serviced, time windows available, load capacity, cost structure, ratings and the type of vehicle the driver uses to transport delivered items. Matching module 222 returns a list of delivery persons satisfying the given criteria. Once buyer 228 selects a delivery person 232, a web service call is made to delivery web service 224, which then triggers a notification module 214 to send a text message or other alert to the delivery person's mobile phone or other device as designated in delivery person's 232 profile contained in database 226.

Billing module 220 may coordinate billing sellers 230 for use of delivery system 100, paying delivery persons 232 and charging buyers 228 for delivery services. Billing module 220 may be configured to electronically pay delivery person 232 upon completion of a delivery or to accumulate payments over a period of time to for a later lump sum payment. Payments by sellers 230 may also be paid at the time a buyer 228 requests a delivery or at the time of pick-up or delivery. Delivery system 100 may be configured to require sellers to pay for deliveries or else buyers to pay. The billing module may also provide a combination, such as buyer paying for a delivery only when the order is less than a threshold amount. Other payment and billing arrangements may be used, for example, a seller 230 may be charged a monthly fee by delivery web service 224 for up to a certain number of deliveries or distance traveled for deliveries. Billing module 220 would then be configured to keep track of the number of deliveries or the distance traveled and bill seller 232 accordingly.

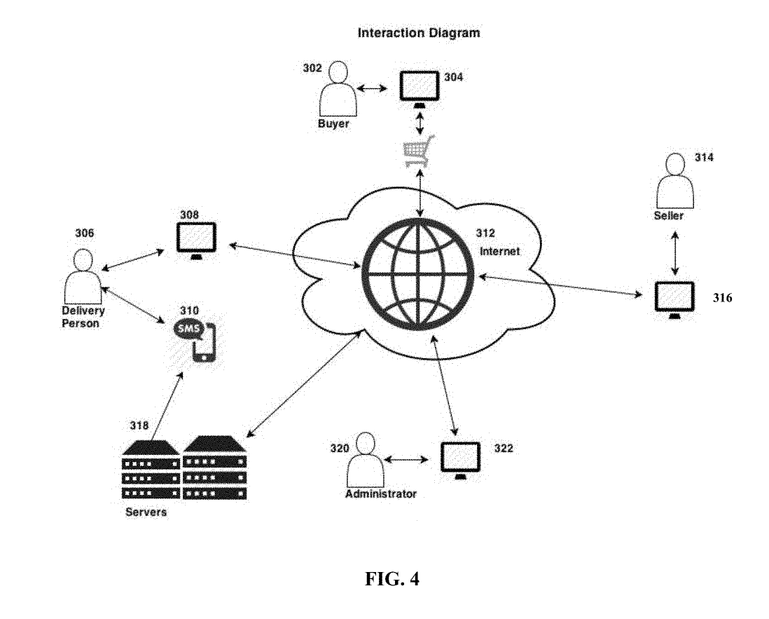

FIG. 4 is an interaction diagram representing the structural organization of objects that send and receive messages and the dynamic, interactive behavior of a delivery system according to an illustrative embodiment. As a web-based system, we have the Internet 312. Note though that theory of this system can be carried out on an intranet when applied to other situations.

There are four objects or individuals participating in the system, administrator 320, buyer 302, seller 314 and delivery person 306. Each participates, i.e. sends and receives messages or signals via device 322, for administrator 320, device 304 for buyer 302, device 316 for seller 314 and device 308 for delivery person 306. Each of devices 304, 308, 316 and 322 receive and transmit information to one another via the Internet 312. Delivery person 306 is also shown to receive and transmit information through device 310, which may be, for example, a short message service (SMS) such as a cellular phone text message. Note that delivery person 306 may participate in the system entirely with a single device or may have more than one device, i.e. device 308 and 310 may be a single device. Similarly, administrator 320, buyer 302 and seller 314 may engage in message flow in the system via one or more devices. In this exemplary embodiment, one or more servers 318 retrieve and transmit data to devices 304, 316, 308, 322 via the Internet 312 forming the network or a portion thereof. The network may be implemented, for example, using a wireless local area network (WLAN) or other wireless or wired system that allows the methods described herein to be effectively carried out. The system may operate in a cloud environment having a cloud service as opposed to or in addition to a dedicated server.

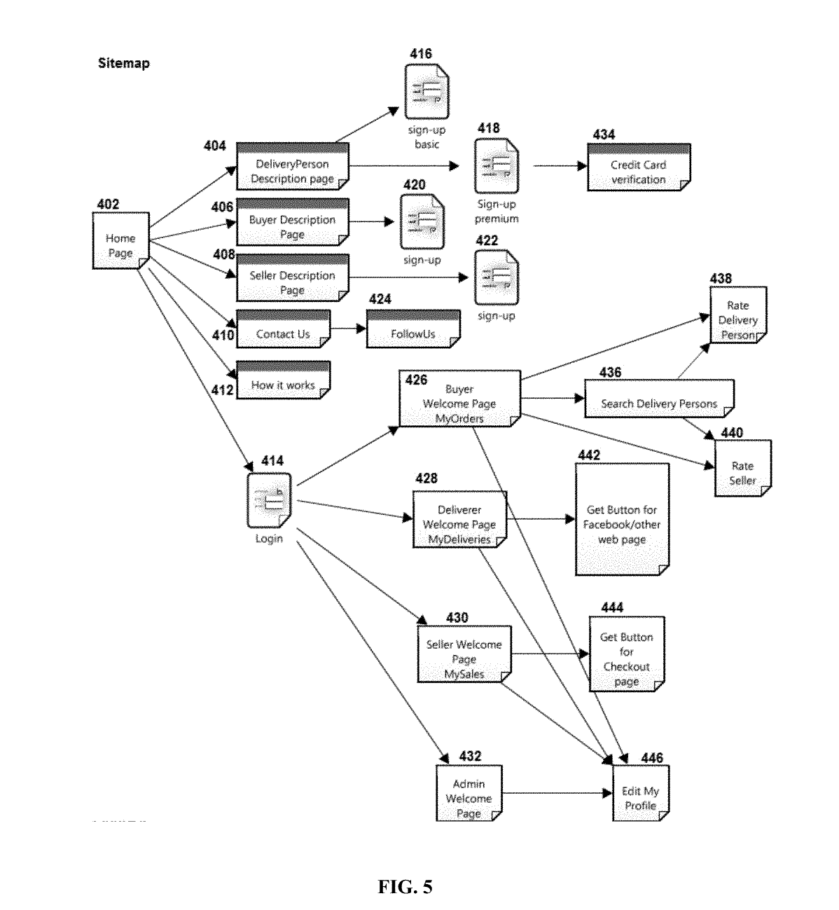

FIG. 5 is a sitemap according to an illustrative embodiment showing the delivery system webpages accessible to administrators, buyers, sellers, delivery persons, and others. The map shown in FIG. 5 is illustrative only, and service to show webpages that may be include in the website. It will be understood that a different structure can be implemented allowing access to particular webpages through different webpages than shown.

According to the illustrative structure shown in FIG. 5, from homepage 402 a user can access a delivery person description 404, buyer description 406, seller description 408, contact information page 410, description of how the delivery service works 412 and login page 414. Contact page 410 is further linked to a “follow us” page 424, through which a user can follow the company on various social media sites, such as Facebook or Twitter.

From the delivery person description page 404, a user can access one or more delivery person signup pages. In the example in FIG. 5, a user may select either a basic sign-up page 416 or a premium sign-up page 418. Basic sign-up may include, for example, marketplace rates without any volume commitments. Premium sign-up may include, for example, discounted fixed price per delivery. A credit card verification page 434 is connected to when deliveries get scheduled on the portal sign-up page 418.

From buyer description page 406, a user can access a buyer signup page 420. From seller description page 408, a user can access a seller signup page 422.

Login page 414 is linked to welcome pages 428, 430, 432, each specific to one of the buyer, delivery person, seller or administrator. From the welcome pages, user can access a profile edit page 446. In this exemplary embodiment, profile edit page 446 is shown as a single page, however, in other embodiments separate profile edit pages can be provided for each type of user, or a portion of users.

Links may be present on buyer welcome page 428 to a delivery person rating page 438, a seller rating page 440 and a delivery person search page 436.

Delivery person welcome page may have one or more links to other webpages, such as a Facebook page as shown by page 442 in FIG. 5.

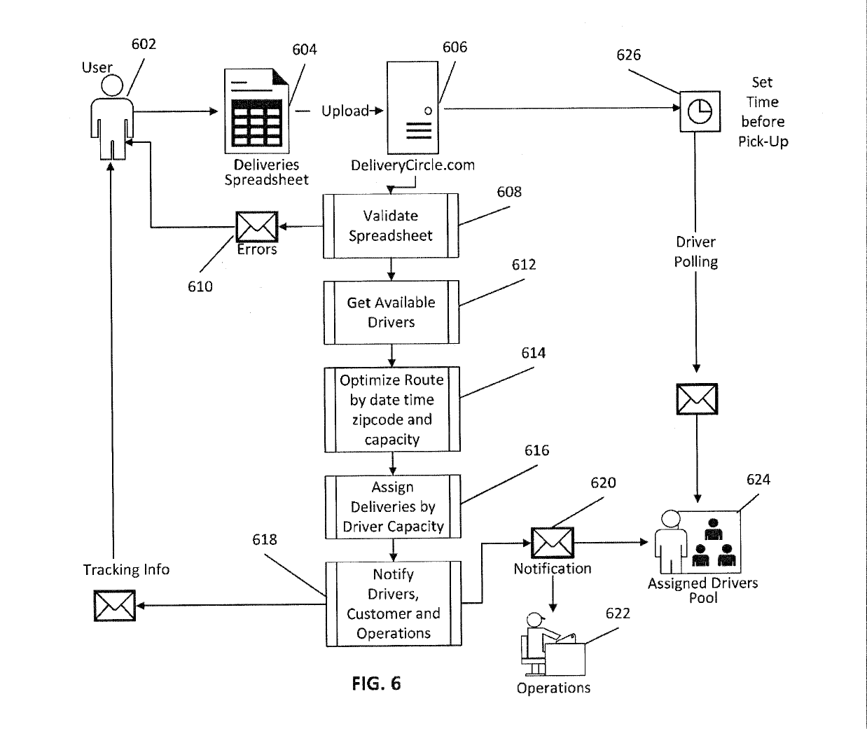

FIG. 6 is a diagram showing scheduling multiple deliveries via a spreadsheet upload, according to an exemplary embodiment. Embodiments of the delivery system allow sellers to schedule multiple deliveries via a spreadsheet upload. The system then generates an optimized route for the delivery person to complete the deliveries, preferably in the shortest possible time. Deliveries may be scheduled automatically, generating a confirmation notice, by email or text for example, with tracking that goes back to the seller, or the buyer as the case may be.

In an exemplary embodiment sellers can schedule multiple deliveries on the system with their assigned drivers all with just one click, or a few online steps, in other words it can be characterized as a single “transaction” once the system has been populated with the relevant information. The deliveries may be picked up from the same location but dropped off to any number of different locations. The delivery system allows for an upload of the spreadsheet for multiple delivers, for example with a maximum of 200 deliveries per sheet. When a spreadsheet is uploaded, the system may optimize the route based on the zip code, dedicated driver assignments to the account, available zip codes and available time for the driver, and automatically schedules the deliveries and sends the notification out to the driver. Each driver in the assigned driver pool has a load capacity associated with their profile. The system will distribute the deliveries in the uploaded spreadsheet taking into account this load capacity. A user, such as a seller 602 prepares a spreadsheet 604, such as an in Excel format for example. Spreadsheet 604 is uploaded to the delivery web service 606. Delivery system 100 validates spreadsheet 604 in step 608. If errors are found, spreadsheet 604 is rejected in step 610 and the rejection is reported to seller 602. If no errors are found, the information on spreadsheet is used together with other information, for example that which is in database 226, to identify available delivery persons in step 612. A delivery route is optimized by various criteria, such as date, time, zip code and capacity, for example in step 614. In step 616 delivery persons are assigned to particular delivery jobs based on driver capacity. After the system determines which delivery persons should be assigned to which jobs, it generates notification 620. Notification 620 that includes information describing the delivery job is sent to an administrator 622 and the delivery persons in the assigned drivers pool 624. The delivery system may be configured to allow the seller to add and delete routes as well as change drivers for the routes.

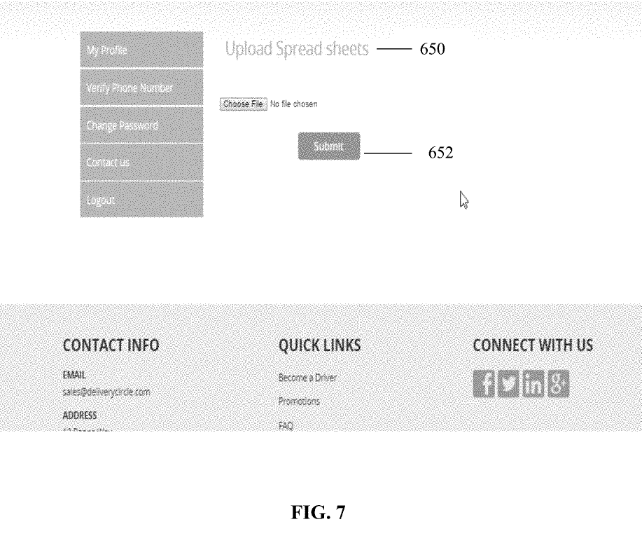

When spreadsheet 604 is uploaded to the delivery web service 606 the time before pick-up is set in step 626. Driver polling takes place beginning at time zero. FIG. 7 depicts a web page according to an illustrative embodiment of delivery service system 100. A seller chooses the “upload spread sheets” button 650, for example. Once the spread sheet is uploaded a user pushes the “submit” button 652.

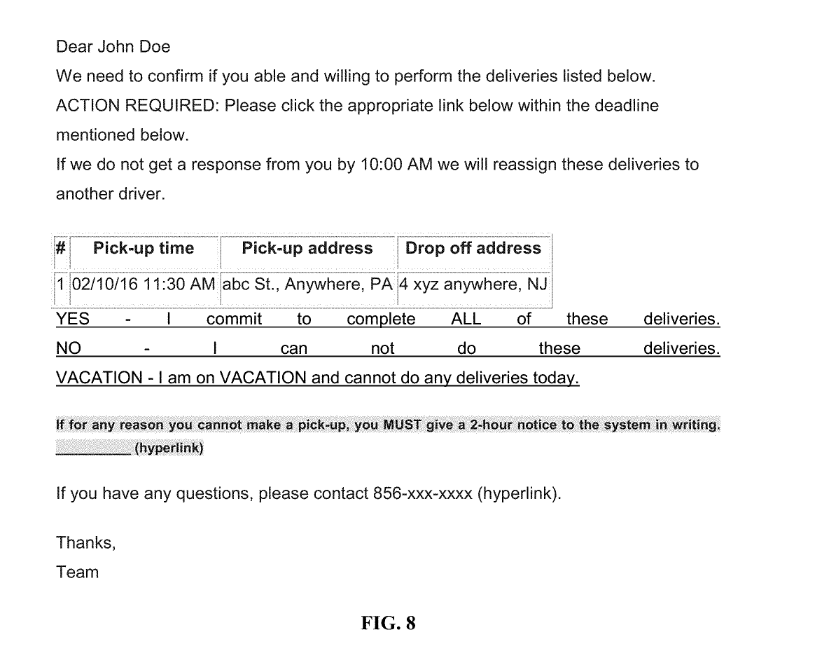

FIG. 8 shows an illustrative driver polling notice. This notice is sent to a delivery person when she has been selected for a delivery job. The notice requests confirmation from the delivery person that she will perform the requested services. A hyperlink is provided for the delivery person's response and a time limit is given for acceptance of the delivery job. The delivery details are given, including pick-up time, pick-up address and drop-off address. More than one delivery job may be sent in a single email, or other type of correspondence transmission, if they are scheduled together. They may include jobs for one or more sellers.

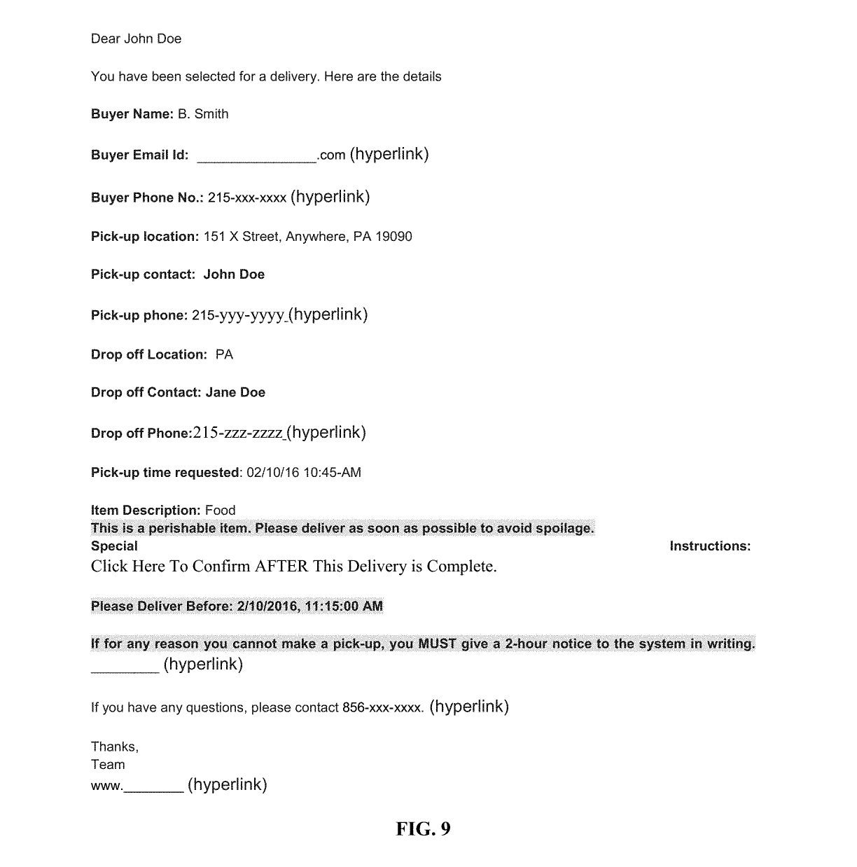

FIG. 9 is an illustrative embodiment of a notice, such as by email, to a delivery person that describes the proposed delivery job, the items to be delivered, and instructions on accepting or rejecting the assignment. In this illustrative embodiment, the buyer's name, phone number and a hyperlink to the buyer's email ID are provided. The pick-up location, pick-up contact and phone number, and requested pick-up and delivery time are also provided. Information about the delivery destination includes the drop-off location, contact person and telephone number. The description of the item(s) to be delivered and any special instructions are also included. A hyperlink is provided to allow the delivery person to easily contact the administrator if the delivery cannot be made. In this embodiment another hyperlink is provided for questions or other issues that may arise regarding the job. A single hyperlink may be used for all contact with the administrator. A link to the delivery service website is also included in the notice.

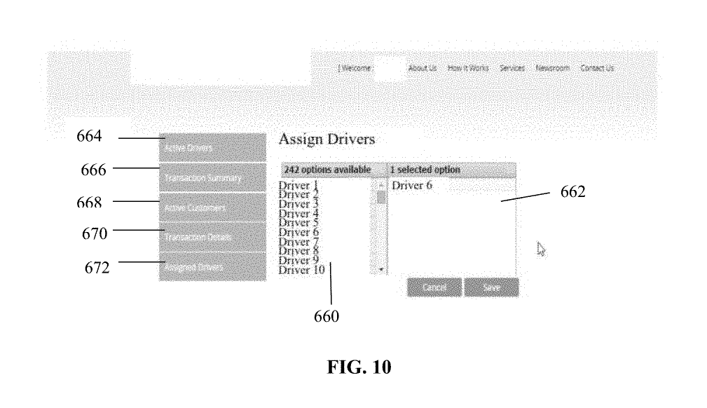

FIG. 10 is a webpage accessed by a seller through which the seller can manage deliveries, including selecting delivery persons. A user selects from the following buttons: active drivers 664, transaction summary 666, active customers 668, system transaction details 670 and assigned drivers 672. Other buttons may be included to assist a buyer in using delivery service 100. FIG. 10 depicts drop-down menu 660, which lists delivery persons the seller may select. The list may include all drivers, or if the seller has previously designated preferred delivery persons, those can be listed, with the option to see additional delivery person should the preferred delivery person not be able to fulfill the request. Once the seller selects a delivery person, the name shows in the selected option inset list 662.

The results of clicking on or selecting buttons 664, 666, 668, 670, 672 and the associated actions will now be described for an illustrative embodiment of the delivery system. It is noted that although the description refers to “buttons”, other graphic user interfaces may be employed.

Selecting active driver button 664 displays a list of active drivers by zip code with details on the driver profile. A delivery system administrator may set the load for each driver through this active driver button 664.

Selecting transaction summary button 666 shows a summary of transactions, which may be filtered, for example, by date, driver or merchant names and or addresses. A delivery system administrator may download the information to a spreadsheet format.

Selecting active customers button 668 shows a list of all active customers on the system. A filter may be provided to categorize and selectively display the active customers, such as by zip code or volume, or other parameter. A delivery system administrator through this link may assign a dedicated pool of drivers for each merchant.

Selecting system transaction details button 670 displays detailed transactions that can be filtered, such as by date, driver or merchant names and or addresses. Through this link a delivery system administrator may download the information to a spreadsheet format. The delivery system administrator has other additional features allowed through this link, features such as cancel a scheduled delivery, change the driver, update the transaction or place the delivery on hold.

Selecting assigned drivers button 672 displays a list of all merchants in the system and the assigned drivers associated with them. Changes to the drivers assigned to particular merchants can be made by a delivery system administrator through this link.

It is noted that although in illustrative embodiments a “delivery system administrator” is designated as the person or entity that can make changes, the system can be configured to allow other parties to make those changes.

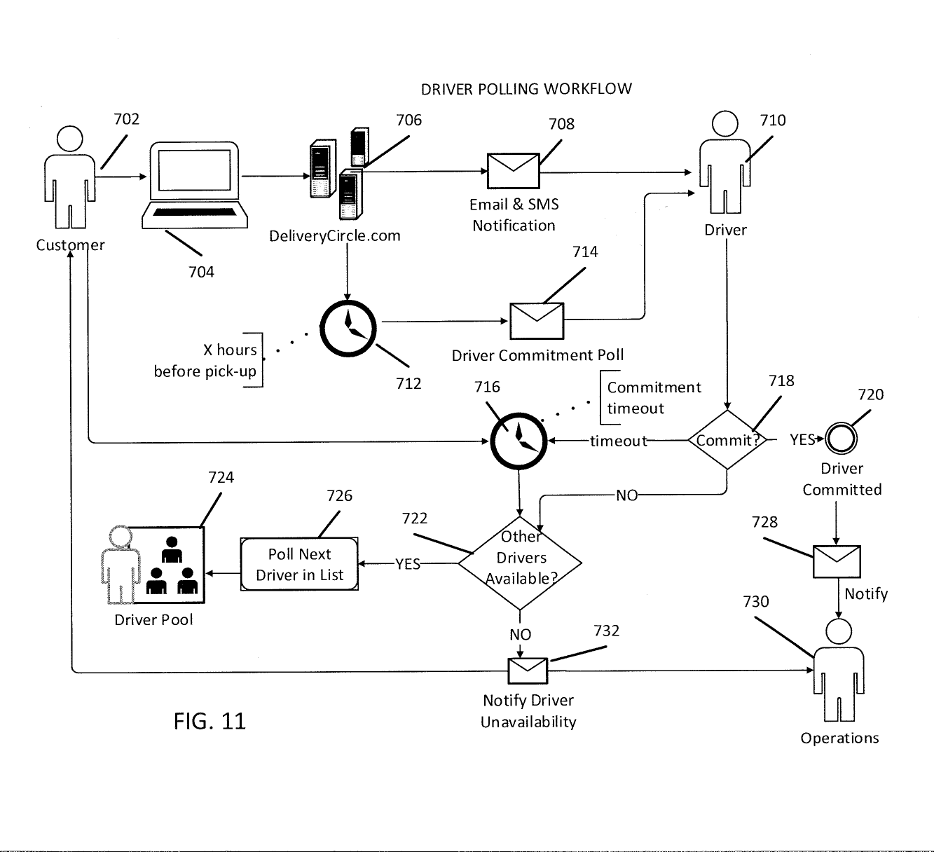

FIG. 11 shows an illustrative driver polling workflow. A Merchant selling the products or a customer buying the product 702 schedules a delivery in step 704, which is sent to delivery web service 706. An email and short message service notification 708, such as a text message, is sent to a delivery person 710. Delivery web service 706 also designates the time before pick-up in step 712. A commitment request 714 is sent to delivery person 710 requesting a commitment to making the delivery. Also sent by delivery web service 706 upon receipt of the delivery request from a seller 702 is a commitment time-out 716. This is a time period by which delivery person 710 must commit to the delivery job in step 718. One of three events may take place regarding a delivery person commitment, delivery person 710 may commit to making the delivery in step 720, reject the job, or the commitment period may time out. If the job is rejected by delivery person 710 or the timeout period has ended, delivery system 100 seeks other available delivery persons in step 722. If no other delivery persons are available a notification 732 is generated and sent to an administrator 730. If other delivery persons are available, the next person in driver pool 724 is polled in step 726 to see if that delivery person will commit to making the delivery. The process can repeat until a delivery person is found, or if no delivery person is found either initially or after repeated process steps, seller 702 is notified. If a delivery person commits to the delivery a notification 728 is sent to administrator 730.

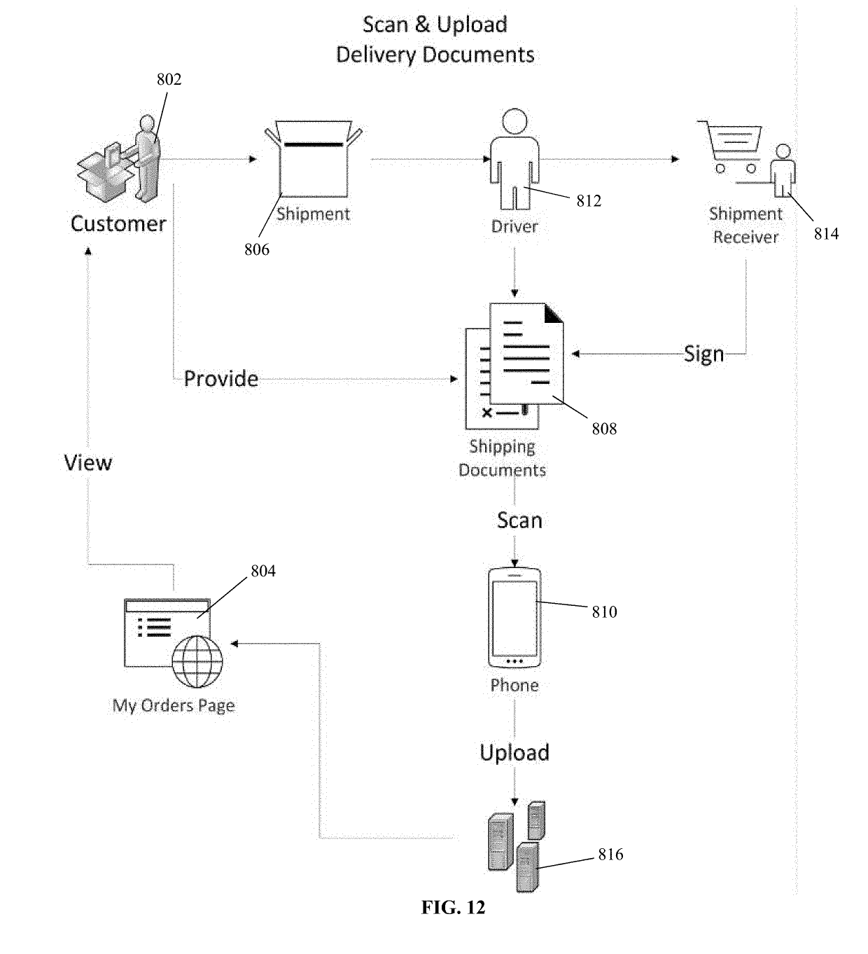

FIG. 12 shows a procedure for scanning and uploading delivery or shipping documents according to an illustrative embodiment. A seller 802 receives an order 804 placed by a buyer. Seller 802 scans shipping documents 808 in step 810 and uploads them to the servers 816 of delivery system 100. Seller 802 packs the purchased product in step 806 and provides the package to delivery person 812. Delivery person 812 transports the package to buyer 814 who then signs shipping documents 808, which are scanned and uploaded to the servers of delivery system 100.

The delivery system may be configured so a delivery person has the capability to upload a shipping and drop off manifest to the order as well as scan pictures of the shipments to the system. A delivery may be tracked from the pick-up time to the delivery. The delivery system may also allow delivery persons or others to upload the manifest into the orders so they can be tracked and seen on the system in real time for reconciliation. The system may also allow users, such as merchants for example, to upload to the delivery system custom delivery procedures, training videos or other information that facilitates delivery. These uploads become a part of the merchant's profile any delivery person serving the business will automatically have access to uploads.

These documents can then be tracked and downloaded by the sellers, or others as designated, when they log in to the system. Various other inventory information may be input into the system.

Shipping documents may include, for example, validated addresses through a map application, such as google maps, contact name and phones, item descriptions, special instructions to the driver, pick up and drop off manifests, pictures of any items, and other information relevant to the delivery process.

The app provides a mechanism for the businesses to outsource their logistics with data analytics and reporting. Without adding to their payroll, the business gets a dedicated driver/drivers to fulfill their logistics.

The delivery system can be configured to have one notification, such as an email for example, to the delivery person generated with multiple line items. In an exemplary embodiment, the delivery person can use the address directly from the notice to pull up in a mapping application.

Sellers may be provided with the capability to choose a dedicated driver or set of drivers and those drivers are assigned to the sellers. Driver preferences and rating can be established. A preference order may be established within the set of drivers that allows the system to split the load of multiple deliveries based on the ratio allocated. Preference order may include various factors such as the size and type of the vehicle, time availabilities of the driver, driver performance, and weight and size of the products transported. Based on any or all of the factors, a load number is assigned by the seller for each driver. A dedicated set of drivers assigned to the account can have different loads, which the system translates to a ratio within the algorithm when optimizing the number of drivers required for multiple deliveries for a given seller.

Driver dispatch and management may be fully or substantially automated. The system has the capabilities to dispatch the drivers automatically by sending a text message, emails or other alerts with delivery details to the drivers and other parties, such as the buyer or administrator who may need delivery-related information. The delivery system thus, in an exemplary embodiment, can be executed with virtually no human intervention required between a requested delivery, the driver dispatch and delivery fulfillment.

The delivery system may include driver polling capabilities. In an illustrative embodiment, sellers may schedule pick-ups using the delivery system for future dates with their assigned delivery persons. At a set time before the pick-up, the system sends a reminder to the delivery person to commit to the delivery and the delivery person is given a set time to accept the delivery. If they decline the delivery or do not respond back within the set time, the system continues to poll other drivers that meet established criteria automatically until a set time period expires. A delivery administrator is notified if a delivery person commitment happens or if the system fails to find a delivery person for the delivery.

An API may be provided to allow sellers to put a button or other link access feature on their website for their buyers to schedule deliveries. This allows sellers to separate logistics and give the control of scheduling to their buyers and have buyers pay for the delivery service directly without the seller acting as a middleman.

Various driver payment systems can be incorporated into the delivery system. In an exemplary embodiment, the delivery system may be configured so the delivery person gets paid as soon as the delivery is completed. Upon confirming the delivery is completed, the delivery system pushes out the calculated payment directly to the delivery person through a third party payment system or other system that allows transfer of funds to the delivery person.

Return deliveries may also be made through an exemplary embodiment of the system. For example, a merchant uses thermal bags for product delivery. The delivery person delivers the product in the thermal bag, but then returns the bag to the merchant. If the return delivery is not yet in the system, the driver may enter it. The driver could also prompt the merchant to enter it, but enabling the driver to make the entry may be more efficient. Return deliveries may not necessarily be an item originating from the merchant, but instead may originate from the recipient of the initial delivery.

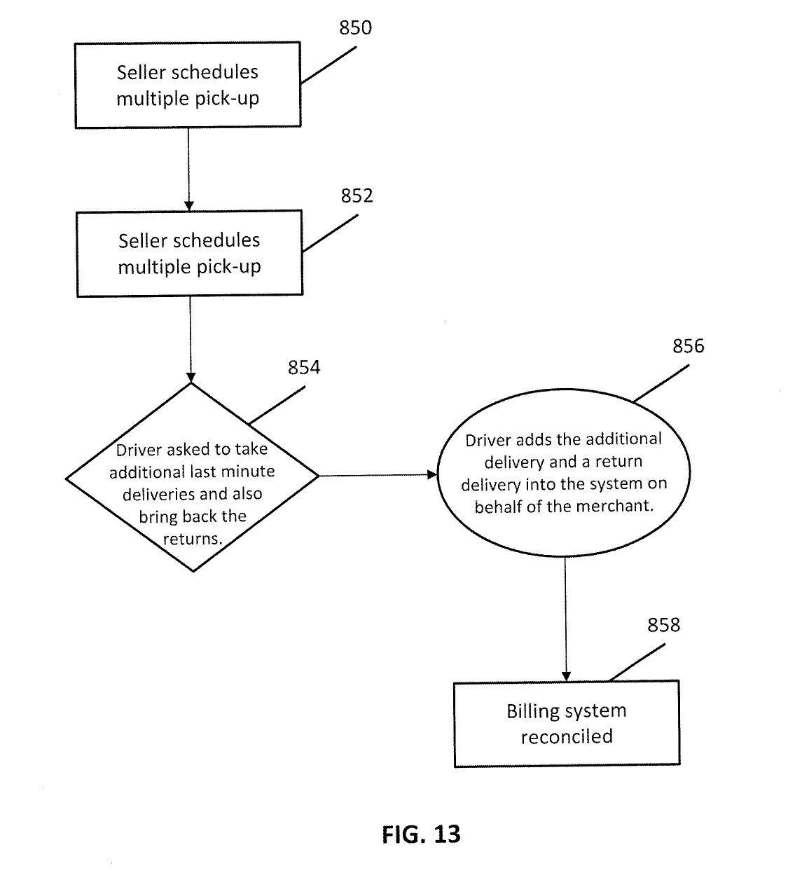

An illustrative return process is shown in FIG. 13. A seller schedules multiple pick-ups in step 850. A delivery person arrives at the pick-up location in step 852. The delivery person is asked to make additional deliveries or return items from the drop-off location to the seller in step 854. The delivery person adds the additional deliveries and return requests in the delivery system in step 856. The delivery system updates or amends billing associated with the delivery requests in step 858.

In an illustrative embodiment driver wait times may be considered in delivery pricing and may be accounted for by the system. For example, the delivery system policy may include a set wait time that is covered in the pricing. A delivery person may initiate a clock beginning, for example at the scheduled pick-up time. When a threshold time has elapsed, the occurrence may be entered automatically into the delivery system and a surcharge automatically added to the cost of the delivery. The system can be configured to charge the buyer or seller for the surcharge, or threshold times may trigger different billing scenarios. Additionally, the delivery system may be configured to notify merchants if the delivery is delayed. Similarly, a buyer may be notified of a delayed delivery.

In an illustrative embodiment, a delivery person may enter comments to improve service. This information can be directed back to merchants. In a further embodiment of the delivery system, a merchant may optimize parameters such as shifting quantities allocated to drivers, i.e. the load per driver.

Embodiments of the delivery system described herein can be used for shipment of goods or management of a labor force, such as independent contractors or a work force without established hours or shift workers across different industries. The system can also be used on a royalty basis as an outsourced logistics platform to scan, store, dispatch and track workers/and or driver(s) where they have their own internal workforce.

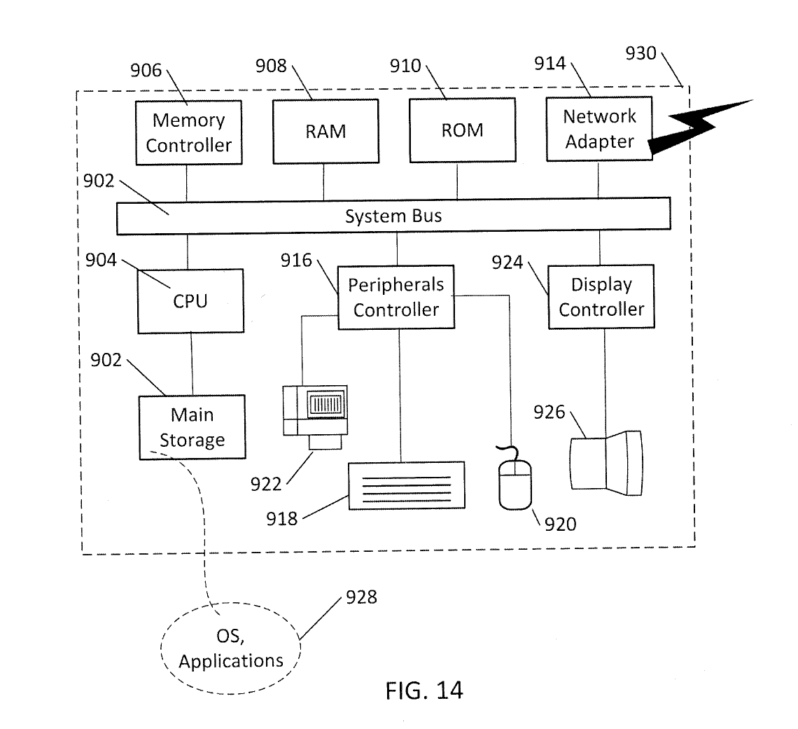

FIG. 14 depicts an illustrative system on which embodiments of the delivery system may be carried out. The methods described herein may be implemented by software and compiled and stored to a memory 902 as software code. During runtime, the software may be invoked for execution by a processor 904. In one implementation, the delivery system is implemented as a single system on a chip, but a plurality of processors may be configured to implement the delivery system. For example, a memory controller 906 may be used to manage the flow of data by interfacing between memory 902 and processor 904. Further shown are random access memory device 908 and read only memory device 910. Electronic components of the delivery system may communicate with one another through any suitable electronic communication mechanism, such as a communication bus 912 or cabling. In other implementations, the delivery system may be implemented on separate hardware modules placed in communication with one another through any suitable electronic communication mechanism, such as a communication bus or cabling. Communication may also be provided wirelessly, such as 802.11 (Wi-Fi), NFC, Bluetooth®, or other suitable technologies. A network adaptor 914 allows the system to communicate over a network with other computers, server or networking device, such as over a LAN connection. A peripheral controller 916 may be configured to facilitate operation of peripheral devices, such as input devices 918, 920 and printer 922. A display controller 924 may be used to connect display 926 to the system. It will be understood that some or all of the components of FIG. 14 may be incorporated into a single device. An operating system 928 can manage computer hardware and software resources of the delivery system.

Illustrative embodiments may offer consumers the option of getting their purchases delivered even if the business does not offer or have its own delivery services. It also may provide a faster and cheaper local deliver option for businesses that do deliver. This solution provides an online marketplace for connecting consumers and businesses that desire items delivered locally with a pool of available drivers who can deliver it the same day, based on their availability, and rating. Embodiments may also be extended to long range deliveries and to various modes of transportation other than on-road vehicles. Illustrative embodiments may provide specified pick up times for scheduled route based deliveries, rush deliveries or any delivery that must arrive at a specific time or during a specific time period. The delivery system may allow geo-positioning of the drivers for just-in-time deliveries, as well as a dedicated pool of driver model for route-based, preferably same day, deliveries.

In the past, the consumer's delivery options for getting items delivered was controlled by the business selling the item. Embodiments of the delivery system allow the consumer to pick a delivery method that is independent of the business. Furthermore, the delivery system substitutes human labor with software and automates the dispatching process, including for example, reassigning deliveries if a particular driver is not able to commit to making a delivery through the polling process.

Furthermore, embodiments of the delivery system may dispatch the delivery person most suitable for the job, thereby optimizing the delivery process.

Embodiments may also provide benefits to people who may sign up as delivery persons to take on jobs while they are commuting to and from work, for example, or are otherwise in route somewhere, or who merely want to earn money in a manner that may allow them to work based on their availability or desired schedule.

Application of the system to temporary or hourly shift workers across different industries may help with the staffing process by optimizing the number of workers needed at any given point in time.

Various embodiments of a delivery system, method, components and non-transitory signals have been described, each having a different combination of elements. The invention is not limited to the specific embodiments disclosed, and may include different combinations of the elements disclosed or omission of some elements and the equivalents of such structures.

While the invention has been described by illustrative embodiments, additional advantages and modifications will occur to those skilled in the art. Therefore, the invention in its broader aspects is not limited to specific details shown and described herein. Modifications and incorporation of equivalent components may be made without departing from the spirit and scope of the invention. Accordingly, it is intended that the invention not be limited to the specific illustrative embodiments, but be interpreted within the full spirit and scope of the appended claims and their equivalents.

Claimed is:

1. A delivery or labor force management method according to any of the methods described herein.

2. A delivery or labor force management system according to any of the systems described herein.

3. A non-transitory signal according to any of the embodiments described herein.

4. The method of claim 1 wherein the driver has the capability to upload the shipping and drop off manifest to the order as well as scan the pictures of the shipments to the system and these documents can be tracked and downloaded by the clients when they log in to the system.

5. The method of claim 1 wherein clients can schedule multiple deliveries on the system with their assigned drivers online;
the system allows for an upload of a spreadsheet with multiple deliveries;
when a spreadsheet is uploaded, the system optimizes the route based on the zip code, dedicated driver assignments to the account, available zip codes and available time for the driver and automatically schedules the deliveries and sends the notification out to the driver;
each driver in the assigned driver pool has a load capacity associated with their profile;
the system will distribute the deliveries in the uploaded spreadsheet taking into account this load capacity; and
one email or other notice gets generated with multiple line items and the drivers can use the address directly from the email to pull up in their default mapping application.

6. The method of claim 1 wherein:
merchants have the capability to choose a dedicated set of drivers and those drivers are assigned to the merchants;
there is a certain pecking order allowed within the set of drivers which allows for the system to split the load of multiple deliveries based on the ratio allocated;
pecking order includes various factors such as the size and type of the car, time availabilities of the driver, driver performance, weight and size of the products transported;
based on any or all of the factors a load number is assigned by the merchant for each driver; and
the dedicated set of drivers assigned to the account can have different loads which the system translates to a ratio within the algorithm when optimizing the number of drivers required for multiple deliveries for a given merchant.

7. The method of claim 1 wherein:
the system has the capabilities to dispatch the drivers automatically by sending a text message, email or other notice with all the delivery details; and
there is little or no human intervention required between a delivery being requested and the driver dispatch and delivery fulfillment.

8. The method of claim 1 wherein:
clients can schedule pick-ups on the system for future dates with their assigned drivers;
at a set time before the pick-up the system sends a reminder to the driver to commit to the delivery and the driver is given a set time to accept the delivery, or if they decline it or do not respond back within the set time, the system continues the poll with other drivers in the zip code automatically until a set time; and
operations gets notified if a driver commitment happens or if the system fails to find a driver for the delivery.

9. The method of claim 1 wherein:
a button is included on a merchant's website for their customers to schedule deliveries on their own; and
merchants can separate logistics and give the control of scheduling to their customers and pay for it separately.

10. The method of claim 1 wherein:
a driver gets a choice to serve a particular customer as well as gets paid as soon the delivery is completed; and
upon confirming the delivery is completed, the system pushes out the calculated payment directly.

11. The system of claim 2 configured so the driver has the capability to upload the shipping and drop off manifest to the order as well as scan the pictures of the shipments to the system and these documents can be tracked and downloaded by the clients when they log in to the system.

12. The system of claim 2 configured so the clients can schedule multiple deliveries on the system with their assigned drivers online;
the system allows for an upload of a spreadsheet with multiple deliveries;
when a spreadsheet is uploaded, the system optimizes the route based on the zip code, dedicated driver assignments to the account, available zip codes and available time for the driver and automatically schedules the deliveries and sends the notification out to the driver;
each driver in the assigned driver pool has a load capacity associated with their profile;
the system will distribute the deliveries in the uploaded spreadsheet taking into account this load capacity; and
one email or other notice gets generated with multiple line items and the drivers can use the address directly from the email to pull up in their default mapping application.

13. The system of claim 2 configured:
to allow merchants to choose a dedicated set of drivers and those drivers are assigned to the merchants;
so there is a certain pecking order allowed within the set of drivers which allows for the system to split the load of multiple deliveries based on the ratio allocated;
so the pecking order includes various factors such as the size and type of the car, time availabilities of the driver, driver performance, weight and size of the products transported;
to assign a load number by the merchant for each driver based on any or all of the factors; and
so the dedicated set of drivers assigned to the account can have different loads which the system translates to a ratio within the algorithm when optimizing the number of drivers required for multiple deliveries for a given merchant.

14. The system of claim 2 wherein configured so:
the system has the capabilities to dispatch the drivers automatically by sending a text message, email or other notice with all the delivery details; and
there is little or no human intervention required between a delivery being requested and the driver dispatch and delivery fulfillment.

15. The system of claim 2 configured wherein:
clients can schedule pick-ups on the system for future dates with their assigned drivers;
at a set time before the pick-up the system sends a reminder to the driver to commit to the delivery and the driver is given a set time to accept the delivery, or if they decline it or do not respond back within the set time, the system continues the poll with other drivers in the zip code automatically until a set time; and
operations gets notified if a driver commitment happens or if the system fails to find a driver for the delivery.

16. The system of claim 2 having a button on a merchant's website for their customers to schedule deliveries on their own; and
merchants can separate logistics and give the control of scheduling to their customers and pay for it separately.

17. The system of claim 2 configured so a driver gets a choice to serve a particular customer as well as gets paid as soon the delivery is completed; and
upon confirming the delivery is completed, the system pushes out the calculated payment directly.
